(19) United States
(12) Patent Application Publication
(10) Pub. No.: US 2010/0062259 A1
(43) Pub. Date: Mar. 11, 2010

(54) METHOD FOR MANUFACTURING LAMINATE AND LAMINATE

(75) Inventors: Toru Umemoto, Ibaraki-shi (JP); Tadayuki Kameyama, Ibaraki-shi (JP); Kazunori Kawamura, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Ibaraki-shi, Osaka (JP)

(21) Appl. No.: 12/514,520

(22) PCT Filed: Jun. 19, 2008
(86) PCT No.: PCT/JP2008/061192

§ 371 Date: Jun. 9, 2009

(30) Foreign Application Priority Data
Aug. 13, 2007 (JP) 2007-210668

(51) Int. Cl. B32B 9/04; B05D 3/04

(52) U.S. Cl. 428/411.1; 427/536

(57) ABSTRACT

The present invention provides a method for manufacturing a laminate having a hydrophobic resin substrate and an orientation layer containing an organic dye, wherein the method comprises a step (1) of carrying out a plasma treatment on a surface of the hydrophobic resin substrate under an atmosphere having a nitrogen concentration of 80% or higher and a step (2) of forming the orientation layer containing the organic dye on the hydrophobic resin substrate by applying a solution containing the organic dye exhibiting lyotropic liquid crystallinity and a hydrophilic solvent on the surface of the hydrophobic resin substrate on which the plasma treatment is carried out and drying the solution.

According to the method for manufacturing the laminate of the present invention, the solution may be applied on the hydrophobic resin substrate approximately uniformly and an excellent orientation layer having an extremely small number of defects may be formed.

### TECHNICAL FIELD

The present invention relates to a method for manufacturing a laminate wherein an orientation layer containing an organic dye is laminated on a surface of a hydrophobic resin substrate, as well as a laminate.

### BACKGROUND ART

Conventionally, methods for forming an orientation layer on a substrate by applying a solution containing an organic dye exhibiting lyotropic liquid crystallinity and water on the substrate and drying it are known (Patent Document 1).

In the case where the substrate is a film containing a hydrophobic resin as a main component, however, the solution is sometimes repelled from a surface of the substrate. As a result, circular holes having a diameter of approximately several millimeters are sometimes generated in the formed orientation layer. In the case where such an orientation layer is incorporated in a liquid crystal display device, for example, the circular holes cause deterioration of properties of the device. In addition, the orientation layer is inferior in terms of the adhesiveness to the substrate, and therefore, there is a risk that the layers may peel from each other.

As a result, manufacture of orientation layers without defects by applying a solution containing an organic dye approximately uniformly on a surface of a substrate containing a hydrophobic resin as a main component has been required.

### [Patent Document 1] Japanese Translation of International Unexamined Patent Publication No. 2004-528603

### DISCLOSURE OF THE INVENTION

An object of the present invention is to provide a method for manufacturing a laminate according to which a solution containing an organic dye can be applied on a surface of a hydrophobic resin substrate approximately uniformly so that an excellent orientation layer can be formed.

Another object of the present invention is to provide a laminate in which an orientation layer containing an organic dye is laminated on a surface of a hydrophobic resin substrate and the orientation layer firmly adheres to the hydrophobic resin substrate.

A method for manufacturing a laminate of the present invention has a hydrophobic resin substrate and an orientation layer containing an organic dye, and characterized in that the method comprises a step (1) of carrying out a plasma treatment on a surface of the hydrophobic resin substrate under an atmosphere having a nitrogen concentration of 80% or higher and a step (2) of forming the orientation layer containing the organic dye on the hydrophobic resin substrate by applying a solution containing the organic dye exhibiting lyotropic liquid crystallinity and a hydrophilic solvent on the surface of the hydrophobic resin substrate on which a plasma treatment is carried out and drying the solution.

According to the above-described manufacturing method, the solution containing the organic dye and the hydrophilic solvent can be prevented from being repelled from the surface of the hydrophobic resin substrate subjected to the plasma treatment under an atmosphere containing a large amount of nitrogen when the above-described solution is applied on the surface of the substrate. As a result, the above-described solution can be applied on the surface of the substrate approximately uniformly. When the applied solution is dried, an orientation layer having an approximately uniform thickness on the surface of which circular holes are not easily generated can be formed on the substrate.

The reason why such an excellent orientation layer can be formed is assumed to be the following.

By carrying out the plasma treatment on the surface of the above-described hydrophobic resin substrate under an atmosphere containing a large amount of nitrogen, a large amount of nitrogen-containing groups such as a C—N group can be introduced on the surface of the hydrophobic resin substrate, in addition to oxygen-containing groups such as a C—O group. These groups form strong hydrogen bonds with the organic dye exhibiting lyotropic liquid crystallinity, and this is assumed to be why an excellent orientation layer can be formed.

As a preferable method for manufacturing the present invention, in the above-described step (1), a carbon ratio on the surface of the hydrophobic resin substrate before the plasma treatment is carried out is from 70% to 100%. Here, the carbon ratio is measured by X-ray photoelectron spectroscopy.

As another preferable method for manufacturing the present invention, in the above-described step (1), a contact angle of water on the surface of the hydrophobic resin substrate before the plasma treatment is carried out is from 70° to 130°.

As another preferable method for manufacturing the present invention, the hydrophilic solvent contains water.

As another preferable method for manufacturing the present invention, in the above-described step (1), an oxygen concentration in the atmosphere where the plasma treatment is carried out is 15% or less.

As another preferable method for manufacturing the present invention, the organic dye has a hydrophilic substituent in a molecular structure.

As another preferable method for manufacturing the present invention, the hydrophilic substituent is at least one group selected from the group consisting of —COOM, —SO₃M, —PO₃M (provided that M indicates a counter ion), —OH, and —NH₂.

As another preferable method for manufacturing the present invention, the hydrophobic resin substrate is a film containing a norbornane-based resin as a main component.

As another preferable method for manufacturing the present invention, in the above-described step (2), a contact angle of water on the surface of the hydrophobic resin substrate on which the plasma treatment is carried out is from 10° to 60° before the solution is applied.

As another preferable method for manufacturing the present invention, in the above-described step (2), a nitrogen ratio on the surface of the hydrophobic resin substrate on which the plasma treatment is carried out is from 3% to 25% before the solution is applied, provided that the nitrogen ratio is a value measured by X-ray photoelectron spectrometry.

As another preferable method for manufacturing the present invention, a thickness of the orientation layer is from 0.1 μm to 2 μm.

In another aspect of the present invention, a laminated is provided.

The laminate of the present invention comprises a hydrophobic resin substrate and an orientation layer containing an organic dye which dissolves in a hydrophilic solvent and exhibits lyotropic liquid crystallinity, wherein a nitrogen ratio on a surface of the hydrophobic resin substrate on which the orientation layer is laminated is from 3% to 25%.

Here, the nitrogen ratio is measured by X-ray photoelectron spectrometry.

In this laminate, the nitrogen ratio on the surface of the above-described hydrophobic resin substrate is from 3% to 25%, and therefore, there is a relatively large amount of nitrogen-containing groups on the surface of the substrate. Organic dyes that can dissolve in hydrophilic solvents can form strong bonds on the surface of substrates having nitrogen-containing groups through hydrogen bonding. Accordingly, in the above-described laminate, the orientation layer having a uniform thickness and the substrate firmly adhere to each other. Therefore, even in the case where the laminate is incorporated in a liquid crystal display device for use for a long period of time, for example, the orientation layer and the substrate hardly peels from each other.

Even when the above-described laminate is used at high temperatures for a long period of time, the substrate and the orientation layer hardly peels from each other. Accordingly, the above-described laminate has excellent durability.

### BEST MODE FOR CARRYING OUT THE INVENTION

### A. Brief Overview of the Present Invention

The present invention provides a method for manufacturing a laminate having a hydrophobic resin substrate and an orientation layer containing an organic dye, wherein the method comprises the following step (1) and step (2). The step (1) is a step of carrying out a plasma treatment on a surface of the hydrophobic resin substrate under an atmosphere having a nitrogen concentration of 80% or higher. The step (2) is a step of forming the orientation layer containing the organic dye on the hydrophobic resin substrate on which the plasma treatment is carried out in the above-described step (1) by applying a solution containing the organic dye exhibiting lyotropic liquid crystallinity and drying the solution.

The method for manufacturing the present invention may comprise other steps as far as the above-described step (1) and step (2) are comprised in the method.

Specific embodiment of the present invention is explained below.

### B. Step (1)

A step (1) carries out a plasma treatment on a surface of the hydrophobic resin substrate under an atmosphere having a nitrogen concentration of 80% or higher.

Here, the surface of the hydrophobic resin substrate is a surface on which an orientation layer is laminated by applying a solution.

The plasma treatment is carried out on at least one side (surface) of the hydrophobic resin substrate.

In the present specification, the hydrophobic resin substrate is a resin film having weak interaction with water and little affinity with water, at least on the surface. This hydrophobic resin substrate includes, for example, a film in which a carbon ratio on the surface of the film is 70% or higher, and preferably from 80% to 100%. The hydrophobic resin substrate includes, for example, a film in which a nitrogen ratio on the surface of the film is 0% or higher and less than 3%, and preferably from 0% to 2%. Also, the hydrophobic resin includes, for example, a film in which an oxygen ratio on the surface of the film is from 0% to 15%, and preferably from 0% to 5%.

Also, the hydrophobic resin substrate includes, for example, a film in which a contact angle of water on the surface of the film is 70° or higher, and preferably from 70° to 130°. Here, the above-described carbon ratio, nitrogen ratio, and oxygen ratio, as well as the contact angle of water are values obtained through measurement on the surface of the hydrophobic resin substrate before the plasma treatment. The above-described carbon ratio, nitrogen ratio and oxygen ratio are all values obtained through measurement through X-ray photoelectron spectrometry (same as below).

The material and laminated constitution of the hydrophobic resin substrate are not particularly limited as far as the surface on which the solution is applied is hydrophobic. The hydrophobic resin substrate is preferably a film excellent in transparency. The light transmittance of the hydrophobic resin substrate in visible light is preferably 80% or higher and more preferably 90% or higher. Here, the light transmittance is a Y value at a substrate thickness of 100 μm, where the Y value is obtained by correcting visibility based on spectrum data measured by a spectrophotometer (trade name: U-4100 type, manufactured by Hitachi, Ltd.,). Also, a Haze value of the hydrophobic resin substrate is preferably 3% or less and more preferably 1% or less. Here, the Haze value is a value measured according to JIS-K7105.

Polymers having essentially no hydrophilic substituent in the molecular structure can be cited as examples of hydrophobic resins for forming the above-described substrate. Thermoplastic polymers having a straight main chain are preferable as the hydrophobic resin. Concretely, as examples thereof include a norbornene-based resin, an olefin-based resin, an acryl-based resin, an amide-based resin, an imide-based resin, an ester-based resin, a carbonate-based resin, a styrene-based resin, and the like. In particular, it is preferable for the hydrophobic resin substrate to be a film having a norbornane-based resin as a main component.

Here, the norbornene-based resin includes a (co)polymer obtained by using a norbornene-based monomer having a norbornene ring as a part or the whole of a starting material (monomer). The (co)polymer represents homopolymer or copolymer.

The hydrophobic resin substrate comprising the norbornene-based resin as a main component has a C[550] (absolute value of the photoelastic coefficient at wavelength of 550 nm) of 1×10⁻¹² m²/N to 20×10⁻¹² m²/N and more preferably from 1×10⁻¹² m²/N to 10×10⁻¹² m²/N.

When a hydrophobic resin substrate having the above-described absolute value of the photoelastic coefficient is used, a laminate having less optical unevenness can be formed.

As the norbornene-based resin, for example, (a) a polymer obtained by hydrogenating a ring-opened (co)polymer made from a norbornene-based monomer and (b) a polymer obtained by addition-(co)polymerizing a norbornene-based monomer may be cited. The ring-opened copolymer made from a norbornene-based monomer includes a polymer obtained by hydrogenating a ring-opened copolymer made from one or more norbornene-based monomers and an α-olefin, a cycloalkene, and/or a non-conjugated diene. The polymer obtained by addition-copolymerizing the norbornene-based monomer includes a polymer obtained by addition-copolymerizing one or more norbornene-based monomers and an α-olefin, a cycloalkene, and/or a non-conjugated diene.

The polymer obtained by hydrogenating a ring-opened (co)polymer made from a norbornene-based monomer may be obtained by methods described in, for example, paragraphs [0059] to [0060] in JP-A-11-116780, paragraphs [0035] to [0037] in JP-A-2001-350017, and others.

The weight average molecular weight (Mw) of the above-described norbornene-based resin is preferably from 20,000 to 500,000. Here, the weight average molecular weight is a value measured by a gel permeation chromatograph method (polystyrene standard) using tetrahydrofuran solvent. The glass transition temperature (Tg) of the norbornene-based resin is preferably from 120° C. to 170° C. Here, the glass transition temperature is a value calculated from a DSC method according to JIS K 7121.

The hydrophobic resin substrate containing the norbornene-based resin and the like as a main component may be obtained by an arbitrary and proper forming process. As the forming process, a solvent casting method, a melt extrusion method, and the like may be cited. Preferably, the hydrophobic resin substrate may be obtained by drawing a film formed by the above forming process. As the drawing treatment, a longitudinal uniaxial drawing method, a transverse uniaxial drawing method, a method of simultaneous biaxial drawing in longitudinal and transverse directions, a method of sequential biaxial drawing in longitudinal direction and transverse direction, and the like may be cited.

As the hydrophobic resin substrate containing the norbornene-based resin as a main component, commercially available film may be used directly. Alternatively, the commercially available film may be used after being subjected to secondary process such as a drawing process and/or a contraction process. As the commercially available film, for example, ARTON series manufactured by JSR Corporation, ZEONOR series manufactured by ZEON Corporation, and the like may be exemplified.

The hydrophobic resin substrate may be a single layer or a laminated film on which two or more layers are laminated. In the case where the hydrophobic resin substrate is the laminated film, as a film constructing the side (surface) on which the solution is applied, a hydrophobic film is used.

Also, when the surface of the hydrophobic resin substrate does not have orientation, an orientation treatment is preferably carried out on the surface of the substrate before the plasma treatment is carried out (before the step (1) is carried out).

As the orientation treatment, (a) an orientation film is formed on the surface of the substrate, (b) a mechanical orientation treatment such as a rubbing treatment is carried out on the surface of the substrate, (c) a chemical orientation treatment such as an optical orientation treatment is carried out on the surface of the substrate, and the like may be exemplified.

The thickness of the hydrophobic resin substrate is not particularly limited as far as the substrate has a sufficient mechanical strength to apply the solution. Generally, the thickness of the substrate is from 30 μm to 200 μm and preferably from 50 μm to 120 μm.

A plasma treatment is carried out on the surface of the above-described hydrophobic resin substrate under an atmosphere having a nitrogen concentration of 80% or higher. As a result of this treatment, a large amount of nitrogen-containing groups can be introduced on the surface of the hydrophobic resin substrate.

Herein, the plasma treatment is a treatment for improving the quality on the surface of the substrate using low temperature plasma generated by causing glow discharge in the air. The plasma treatment according to the present invention can be carried out under pressure of 9.8 kPa (0.1 kgf/cm²) to 107.9 kPa (1.1 kgf/cm²) at a temperature in a range of 10° C. to 80° C. at the time of the discharge treatment. The intensity of irradiation in the above-described plasma treatment is, for example, 0.1 W·sec/cm² to 50 W·sec/cm² and preferably 1.0 W·sec/cm² to 10 W·sec/cm².

The atmosphere at the time of the above-described plasma treatment has a nitrogen concentration of 80% or higher. The atmosphere may be filled with nitrogen solely (in this case, the nitrogen concentration is approximately 100%). Alternatively, the atmosphere may include a gas other than nitrogen. As the other gas, noble gases such as helium, argon, and the like, gases such as oxygen, moisture vapor, carbon dioxide, ammonia, methane, and the like may be exemplified. Among them, the preferable other gas is ammonia. This is because that more nitrogen-containing groups (C—N group or the like) can be introduced on the surface of the hydrophobic resin substrate under an atmosphere having ammonia gases.

The nitrogen concentration in the atmosphere is preferably 90% or higher and more preferably 95% or higher. On the other hand, the upper limit of the nitrogen concentration is 100% (100% or less). By increasing the nitrogen concentration, more nitrogen-containing groups can be introduced on the surface of the hydrophobic resin substrate.

In the case where the nitrogen concentration in the atmosphere is less than 100%, it is preferable for the other gas to include as little oxygen as possible. In the case where there is a large amount of oxygen in the vicinity of the electrodes when the plasma treatment is carried out, it sometimes becomes difficult to introduce nitrogen-containing groups originating from the nitrogen gas on the surface of the hydrophobic resin substrate, because oxygen is more active than nitrogen.

Based on this standpoint, the oxygen concentration in the atmosphere is preferably 15% or less, more preferably 10% or less, and particularly preferably 5% or less. Here, the lower limit of the oxygen concentration is 0% (0% or higher).

After the plasma treatment is carried out, a large amount of nitrogen-containing groups are introduced on the surface of the substrate.

The nitrogen ratio of the surface of the substrate after the plasma treatment is carried out is from 3% to 25% and preferably 10% to 25%. Also, the oxygen ratio of the surface of the substrate after the plasma treatment is carried out is from 0% to 15% and preferably from 0% to 10%. The carbon ratio of the surface of the substrate after the plasma treatment is carried out is from 65% to 97% and preferably from 70% to 85%.

The surface of the substrate on which nitrogen-containing groups are introduced exhibits hydrophilic property, so that the contact angle of water becomes small. Specifically, in the surface of the substrate, the contact angle of water after the plasma treatment is carried out is from 10° to 60° and preferably from 10° to 40°.

By introducing nitrogen-containing groups on the surface of the substrate, an organic dye described below can form hydrogen bonds with the nitrogen-containing groups. Therefore, when the solution containing the organic dye and a hydrophilic solvent is applied on the surface of the substrate after the plasma treatment is carried out, the organic dye and the hydrophilic solvent bond excellently with the nitrogen-containing groups on the surface of the substrate. Thus, the applied solution is repelled hardly from the surface of the substrate. Accordingly, the solution can be applied with an approximately uniform thickness.

### C. Step (2)

A step (2) forms an orientation layer containing an organic dye on the hydrophobic resin substrate by applying a solution containing an organic dye and drying the solution.

The solution contains an organic dye exhibiting lyotropic liquid crystallinity and a hydrophilic solvent.

The organic dye is a dye exhibiting lyotropic liquid crystallinity and dissolvable in a hydrophilic solvent. The lyotropic liquid crystallinity is a property that phase transfer between an isotropic phase and a liquid crystal phase occurs when the temperature, concentration, or the like thereof is changed. The liquid crystal phase is not particularly limited and a nematic liquid crystal phase, a smectic liquid crystal phase, and a cholesteric liquid crystal phase may be cited. Among them, an organic dye exhibiting the nematic liquid crystal phase is preferably used. This is because the organic dye exhibiting the nematic liquid crystal phase is excellent in orientation. Here, the nematic liquid crystal phase can be identified and confirmed from an optical pattern when observed by using a polarization microscope.

The solubility of the organic dye in a hydrophilic solvent (based on water) is preferably from 0.1 to 40 parts by mass and more preferably from 1 to 20 parts by mass with respect to 100 parts by mass of water. The organic dye is preferably an organic dye having a hydrophilic substituent in the molecule. This is because the organic dye having the hydrophilic substituent can dissolve in a hydrophilic solvent excellently. The hydrophilic substituent is not particularly limited as far as the substituent has high polar character. The hydrophilic substituent is preferably at least one group selected from the group consisting of —COOM, —SO₃M, —PO₃M, —OH, and —NH₂.

Here, M in the above hydrophilic substituent indicates counter ion. The M is preferably a hydrogen atom, an alkali metal atom, an alkaline earth metal atom, a metal ion, a substituted or unsubstituted ammonium ion, or the like. As the metal ion, for example, Ni²⁺, Fe³⁺, Cu²⁺, Ag⁺, Zn²⁺, Al³⁺, Pd²⁺, Cd²⁺, Sn²⁺, Co²⁺, Mn²⁺, Ce³⁺, or the like may be exemplified.

As the organic dye, a compound, which absorbs light of a certain wavelength between 380 nm and 780 nm may be used preferably. This is because an orientation layer containing the organic dye performs as a polarizer. Here, the polarizer is an optical member having a function of converting a natural light or a polarized light into a linearly polarized light.

In accordance with classification according to chemical structure, the organic dye includes an azo-based pigment, an anthraquinone-based pigment, a perylene-based pigment, an indanthrone-based pigment, an imidazole-based pigment, an indigoid-based pigment, an oxazine-based pigment, a phthalocyanine-based pigment, a triphenylmethane-based pigment, a pyrazolone-based pigment, a stilbene-based pigment, a diphenylmethane-based pigment, a naphthoquinone-based pigment, a methocyanine-based pigment, a quinophthalone-based pigment, a xanthene-based pigment, an alizarin-based pigment, an acridine-based pigment, a quinonimine-based pigment, a thiazole-based pigment, a methine-based pigment, a nitro-based pigment, a nitroso-based pigment, and the like. Among these, the preferable organic dye is an azo-based pigment, an anthraquinone-based pigment, a perylene-based pigment, an indanthrone-based pigment, and an imidazole-based pigment. These organic dyes may be used singly or in combination of two or more kinds.

Specifically, the organic dye is preferably a dye exhibiting lyotropic liquid crystallinity represented by the following general formula (1).

(Chromogen)(X)ₙ. Formula (1)

In the formula (1), X is a hydrophilic substituent. As described above, the hydrophilic substituent has high polar character. The X is preferably at least one group selected from the group consisting of —COOM, —SO₃M, —PO₃M, —OH, and —NH₂. The M denotes the same counter ion as described above. In the formula (1), n denotes a number of substituents (integer of 0 or more, generally integer of 1 to 6). In the formula (1), the chromogen preferably includes an azo derivative unit, an anthraquinone derivative unit, a perylene derivative unit, an indanthrone derivative unit, and/or an imidazole derivative unit.

As the organic dye represented by the general formula (1), the chromogen such as an azo derivative unit and a polycyclic compound becomes a hydrophobic moiety in the solution, and the hydrophilic substituent and a salt thereof become a hydrophilic moiety in the solution. With the balance of the hydrophobic and hydrophilic moieties, the hydrophobic moieties and the hydrophilic moieties are respectively combined to develop a lyotropic liquid crystalline phase.

As the specific example of the organic dye represented by the general formula (1), the compounds represented by the following formula (2) to (8) are exemplified.

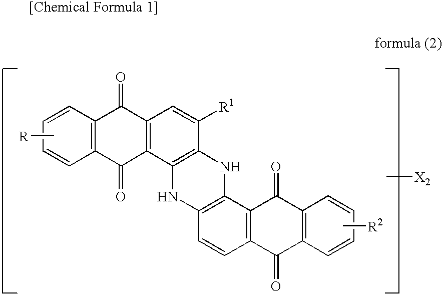

In the formula (2), R¹ represents hydrogen or chlorine, R² and R represent hydrogen, an alkyl group, ArNH or ArCONH. The alkyl group has preferably a carbon number of 1 to 4, and a methyl group or an ethyl group is more preferable. The aryl group (Ar) is preferably a substituted or unsubstituted phenyl group, and a phenyl group which is unsubstituted or substituted with chlorine at the 4-position is more preferable. X is as defined in the above general formula (1).

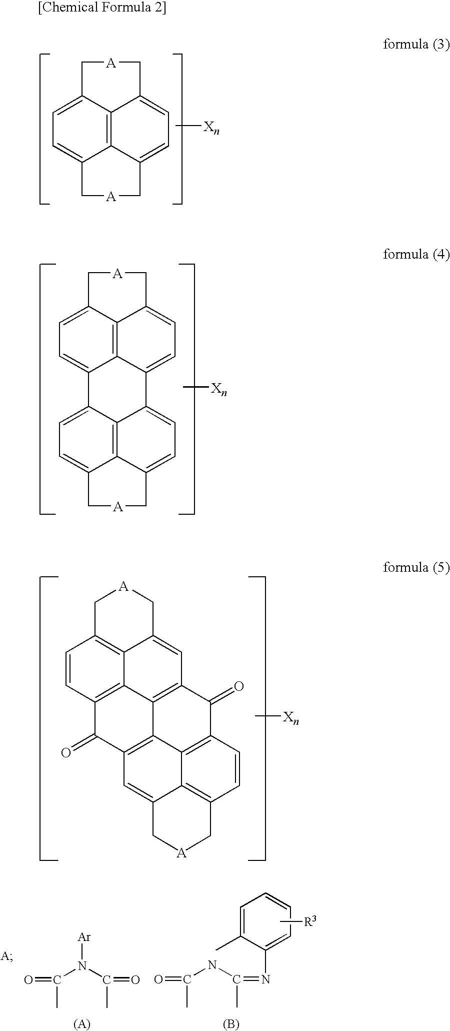

In the formulas from (3) to (5), A is represented by the formula (A) or (B), and n is 2 or 3. R³ of formula (B) represents hydrogen, an alkyl group, halogen, or an alkoxy group, and Ar of formula (A) represents a substituted or unsubstituted aryl group. The alkyl group preferably has a carbon number of 1 to 4, and a methyl group or an ethyl group is more preferable. The halogen is preferably bromine or chlorine. Further, the alkoxy group preferably has a carbon number of 1 or 2, and a methoxy group is more preferable. The aryl group is preferably a substituted or unsubstituted phenyl group, and a phenyl group which is unsubstituted, or substituted with a methoxy group, an ethoxy group, chlorine, or a butyl group at the 4-position, or substituted with a methyl group at the 3-position is more preferable. X is as defined in the above general formula (1).

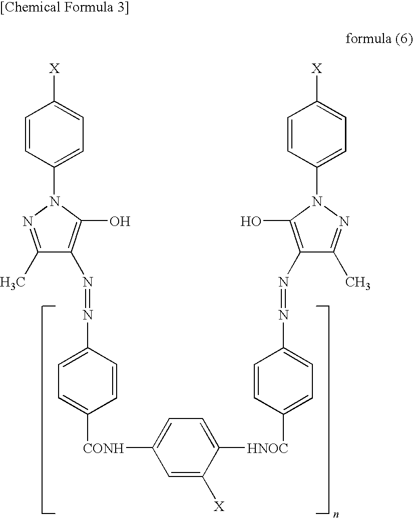

In the formula (6), n is an integer of 3 to 5, and X is as defined in the general formula (1).

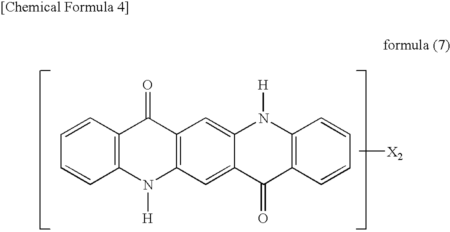

In the formula (7), X is as defined in the above general formula (1).

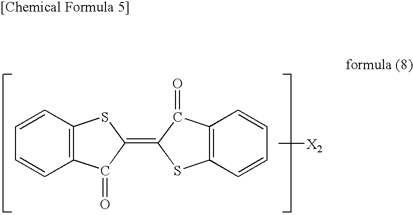

In the formula (8), X is as defined in the above general formula (1).

As the organic dye, for example, the compounds disclosed in Japanese Unexamined Patent Publication No. 2006-047966, Japanese Unexamined Patent Publication No. 2005-255846, Japanese Unexamined Patent Publication No. 2005-154746, Japanese Unexamined Patent Publication No. 2002-090526, Japanese Translation of International Unexamined Patent Publication No. 8-511109, and Japanese Translation of International Unexamined Patent Publication No. 2004-528603 may be used.

Further, a commercial organic dye can be used as the organic dye. For example, the commercial organic dye is C.I. DirectB67, DSCG (INTAL), RU31.156, Methyl orange, AH6556, Sirius Supra Brown RLL, Benzopurpurin, Copper-tetracarboxyphthalocyanine, Acid Red 266, Cyanine Dye, Violet 20, Perylenebiscarboximides, Benzopurpurin 4B, Methyleneblue (Basic Blue 9), Brilliant Yellow, Acid Red, 18, or Acid Red 27.

The hydrophilic solvent is used for dissolving the organic dye and developing lyotropic liquid crystalline phase. As the hydrophilic solvent, water; primary alcohols such as methanol, ethanol, propanol, or butanol; secondary alcohols such as isopropanol or isobutanol; tertiary alcohols such as tert-butanol; diols such as ethylene glycol, propylene glycol, or butyleneglycol; polyols such as polyethyleneglycol; cyclic amines such as pyridine or imidazole; cyclic ethers such as tetrahydrofuran; cellosolves such as methyl cellosolve or ethyl cellosolve; acetone, and the like may be exemplified.

Particularly preferably, as the hydrophilic solvent, water solely or a mixed solvent containing water and the hydrophilic solvent except water may be used. Also, when the hydrophilic solvent contains water, the electric conductivity of the water is preferably 20 μS/cm or less, more preferably from 0.001 μS/cm to 10 μS/cm and particularly preferably from 0.001 μS/cm to 5 μS/cm. By using water in which the electric conductivity is within the above range, an orientation layer having a small thickness variation and being excellent in durability can be formed. Here, the above electric conductivity denotes the degree of passing electricity of a substance, and also denotes the conductivity between electrodes that have a sectional area of 1 cm² and facing each other with a distance of 1 cm. The above electric conductivity (μS/cm) is a value measured by using of a solution electroconductivity meter (manufactured by Kyoto Electronic Manufacturing Co., Ltd., product name: CM-117).

The concentration of the organic dye in the solution is adjusted depending on kinds of the used organic dye within the solution exhibits lyotropic liquid crystallinity. The concentration of the organic dye is preferably from 1 to 40% by mass and more preferably from 1 to 30% by mass. These concentrations of the organic dye usually allow the solution to exhibit stable liquid crystalline state. Here, when at least the solution is prepared, the solution exhibits liquid crystallinity. Accordingly, when the solution is applied on the surface of the substrate, the solution needs not exhibit liquid crystallinity.

Further, in the solution, an arbitrary additive agent may be mixed as needed. As the additive agent, for example, a surfactant, a plasticizer, a thermal stabilizer, an optical stabilizer, a lubricant, an antioxidant, an ultraviolet absorber, a flame retardant, a coloring agent, an antistatic agent, a compatibility improving agent, a cross-linking agent, and a thickening agent may be exemplified. When these additive agents are mixed, the additive amount thereof is preferably more than 0 part by mass and 10 parts by mass or less with respect to 100 parts by mass of the solution. Among the additive agents, the surfactant improves properties (the wettability or the application property to the surface of the substrate) of the solution. Accordingly, the surfactant is preferably mixed in the solution. The surfactant is preferably a nonionic surfactant. The additive amount of the surfactant is preferably more than 0 part by mass and 5 parts by mass or less with respect to 100 parts by mass of the solution.

The solution is applied on the surface of the substrate on which the plasma treatment is carried out.

As a method of applying the solution on the surface of the substrate, a proper coater is properly used. As the proper coater, a reverse roll coater, a positive rotation roll coater, a gravure coater, a knife coater, a rod coater, a slot die coater, a slot orifice coater, a curtain coater, a fountain coater, an air doctor coater, a kiss coater, a dip coater, a bead coater, a blade coater, a cast coater, a spray coater, a spin coater, an extrusion coater, a hot-melt coater, and the like may be exemplified. The coater is preferably the reverse roll coater, the positive rotation roll coater, the gravure roll coater, the rod coater, the slot die coater, the slot orifice coater, the curtain coater, and the fountain coater. By applying the solution with use of the above coater, an orientation layer having less unevenness in the thickness can be obtained.

Though the rate of application of the above-described solution is not particularly limited, it is preferably 100 mm/sec or higher, more preferably from 500 mm/sec to 8,000 mm/sec, particularly preferably from 800 mm/sec to 6,000 mm/sec, and most preferably from 1,000 mm/sec to 4,000 mm/sec. When the solution is applied at such a rate of application, an appropriate shearing force for orienting the organic dye in the solution is applied. Therefore, an orientation layer having a high dichroic ratio and less unevenness in the thickness can be obtained.

Here, even in the case where the surface of the substrate does not have orientation, the organic dye is oriented in one direction by applying shearing force when the solution containing the above-described organic dye is applied. However, it is preferable to carry out an orientation treatment on the surface of the hydrophobic resin substrate before carrying out the plasma treatment (before carrying out the step (1)) in order to form an orientation layer having an excellent dichroic ratio through appropriate orientation of the organic dye.

The solution is suitably dried with use of a proper method. As the drying method, for example, a natural air drying method, an air-circulation type thermostatic oven by which hot air or cool air circulates, a heater using a microwave, a far infrared ray, or the like, a roll heated for temperature adjustment, a heat pipe roll, or a metal belt, and the like may be used.

The drying temperature of the solution is below or equal to the isotropic phase transition temperature of the solution, and it is preferable to dry the solution by gradually raising the temperature from low temperature to high temperature. The drying temperature is preferably from 10° C. to 80° C. and more preferably from 20° C. to 60° C. Within such a temperature range, an orientation layer having less unevenness in the thickness can be obtained.

The drying time of the solution is properly selected depending on the drying temperature and kinds of the solvent. For obtaining an orientation layer having less unevenness in the thickness, the drying temperature is, for example, from 1 to 60 minutes and preferably from 5 to 40 minutes.

By removing the solvent practically, an orientation layer containing the organic dye can be formed on the surface of the hydrophobic resin substrate. The laminate obtained in this way has a structure comprising the hydrophobic resin substrate and the orientation layer laminated on the surface of the substrate.

The thickness of the orientation layer is preferably from 0.1 μm to 2 μm and more preferably from 0.2 μm to 0.5 μm.

In the thus obtained laminate, the nitrogen ratio on the surface of the hydrophobic resin substrate on which the orientation layer is laminated (that is to say, the surface of the hydrophobic resin substrate in the interface between the hydrophobic resin substrate and the orientation layer) is from 3% to 25% and preferably from 10% to 25%. In addition, the orientation layer contains the above-described organic dye, and therefore, the organic dye combines with the nitrogen-containing group of the hydrophobic resin substrate through hydrogen bonding. Therefore, the hydrophobic resin substrate and the orientation layer firmly adhere to each other in the above-described laminate.

Here, the oxygen ratio on the surface of the hydrophobic resin substrate on which the orientation layer is laminated is from 0% to 15% and preferably from 0% to 10%. The carbon ratio thereof is from 65% to 97% and preferably from 70% to 85%.

Also, in the laminate, the solution is repelled hardly from the surface of the substrate when the solution is applied. Thus, the orientation layer formed by drying the solution doesn't generate circular holes in the surface thereof and has an approximately uniform thickness.

Furthermore, in the case where the above-described organic dye is a compound which absorbs light of a certain wavelength between 380 nm and 780 nm, the orientation layer containing the dye has absorption dichroism at a certain wavelength between 380 nm and 780 nm. Orientation layers having dichroism can be used as polarizers. The dichroic ratio of the orientation layer is preferably 5 or higher and more preferably from 10 to 50 at maximum absorption wavelength. Here, the dichroic ratio is measured by the measuring method described in the following Examples.

Further, polarization degree of the orientation layer, which can be used as the polarizer, is 90% or higher and preferably 95% or higher. Also, the single transmittance of the orientation layer, which can be used as the polarizer, is 35% or higher and preferably 40% or higher. Here, the single transmittance is a Y value of three-stimulus value based on the two-time field of view according to JIS Z 8701-1995. The polarization degree can be calculated by measuring parallel transmittance (H₀) and orthogonal transmittance (H₉₀), and using the formula: polarization degree (%)={(H₀−H₉₀)/(H₀+H₉₀)}^{1/2}×100. The parallel transmittance (H₀) is a value of the transmittance of a parallel-type laminate fabricated by laminating two of the optical laminates that are measurement object such that the absorption axes thereof will be parallel to each other. The orthogonal transmittance (H₉₀) is a value of the transmittance of an orthogonal-type laminate fabricated by laminating two of the optical laminates that are measurement object such that the absorption axes thereof will be orthogonal to each other. Here, these transmittances are Y values subjected to vision sensitivity correction by the two-time field of view (C light source) according to JIS Z 8701-1982. The single transmittance and the polarization degree are measured by using a spectrophotometer (manufactured by Murakami Color Research Laboratory Co., Ltd., product name: “DOT-3”) under the condition of 23° C. and the wavelength of 550 nm is used as a standard.

### D. Other Step

The method for manufacturing the laminate of the present invention preferably comprises the following step (3) after the step (2).

The step (3) is a step of bringing the surface (an apposite surface where the substrate is laminated) of the orientation layer obtained by the above step (2) into contact with a solution containing at least one kind of a compound salt selected from the group consisting of aluminum salt, barium salt, lead salt, chromium salt, strontium salt, and compound salts having two or more amino groups in a molecule.

In the present invention, the step (3) is performed for that the orientation layer will be imparted property of insolubility or difficult solubility to water. Specifically, as the compound salt, aluminum chloride, barium chloride, lead chloride, chromium chloride, strontium chloride, 4,4′-tetramethyldiaminodiphenylmethane hydrochloride, 2,2′-dipyridyl hydrochloride, 4,4′-dipyridyl hydrochloride, melamine hydrochloride, tetraminopyrimidine hydrochloride, and the like may be exemplified. An orientation layer excellent in water resistance can be obtained by bringing the orientation layer into contact with these compound salts.

In the solution containing the above compound salt, the concentration of the compound salt is preferably from 3 to 40% by mass and more preferably from 5 to 30% by mass. By bringing an orientation layer into contact with the compound salt with these concentration, the orientation layer excellent in water resistance can be obtained.

As a method for bringing the surface of the orientation layer into contact with the solution containing the compound salt, for example, (a) a method of applying the solution containing the compound salt on the surface of the orientation layer, (b) a method of immersing the surface of the orientation layer into the solution containing the compound salt, or the like may be cited. In the case where these methods are adopted, the surface of the orientation layer is preferably washed with water or an arbitrary solvent for removing the solution containing the compound salt from the surface of the orientation layer on which the step (3) is performed.

### E. Laminate and Application Thereof

In the laminate obtained by the method for manufacturing the present invention, the orientation layer thereof may be a polarizer, so that the laminate may be used as a polarizing plate.

The laminate of the present invention may be used singly or laminated other layers thereon further.

As the other layers, a birefringence layer, a protective layer, an adhesive layer, and the like may be cited.

The birefringence layer is a layer exhibiting predetermined retardation and also called a retardation layer or a compensation layer. The birefringence layer comprises one layer or two or more layers. The birefringence layer is provided on the back surface (the surface opposite to the surface on which the orientation layer is laminated) of the substrate of the laminate of the present invention. Alternatively, the birefringence layer is provided on the back surface (the surface opposite to the surface laminated on the substrate) of the orientation layer. The protective layer is a layer for protecting the laminate. The hydrophobic resin substrate has a function of protecting the orientation layer, so that the protective layer is usually provided on the back surface of the orientation layer of the laminate. The adhesive layer is a layer that bonds both surfaces of neighboring members to integrate these members with each other by practically sufficient adhesive force in a practically adequate adhering time. As materials for forming the adhesive layer, for example, an adhesive agent, an anchor coating agent, and the like may be exemplified. In accordance with classification according to form, concrete examples of adhesives include a solvent type adhesive, an emulsion type adhesive, a pressure-sensitive adhesive, a resoluble adhesive, a condensation polymerizing adhesive, a non-solvent type adhesive, an adhesive in film form and a hot melt type adhesive. In accordance with classification according to chemical structure, concrete examples of adhesives include a synthetic resin adhesive, a rubber based adhesive and a natural substance adhesive. Here, the above-described adhesives include viscoelastic substances (also referred to as pressure-sensitive adhesives) having adhesiveness that can be sensed through contact with pressure at room temperature.

The laminate of the present invention may be used for arbitrary and proper applications. Preferably, the laminate (and the laminate on which other layers are laminated) of the present invention is incorporated in a liquid crystal display device.

As applications of the liquid crystal display device comprising the laminate of the present invention, for example, OA apparatus such as a personal computer monitor, a notebook personal computer, and a copying machine; portable apparatus such as a portable telephone, a clock, a digital camera, a portable digital assistance (PDA), and a portable game machine; a home-use electric apparatus such as a video camera, a TV set, and an electronic range; apparatus to be mounted on a vehicle such as a back monitor, a monitor for a car navigation system, and a car audio device; an exhibition apparatus such as an information monitor for commercial shops; guarding apparatus such as a monitor for supervision; and assisting and medical apparatus such as a monitor for assisting senior persons and a monitor for medical use may be cited.

### EXAMPLES

Hereafter, the present invention will be further described by showing Example and Comparative Examples. However, it is to be noted that the present invention is not limited to these Examples. Here, the measuring methods used in Examples are as follows.

### (1) Method for Measuring Carbon Ratio, Oxygen Ratio and Nitrogen Ratio in Substrate Using X-Ray Photoelectron Spectrometry:

The substrate used in Example and Comparative Examples was cut into a piece of approximately 5 mm×5 mm. This sample was pressed with a Mo plate and fixed to a support, and the carbon in the sample was measured by using ESCA (Quantum 2000, manufactured by ULVAC-PHI Incorporated). Monochrome AIKα was used as the X-ray source and the angle at which photoelectrons were emitted was 45° relative to the surface of the sample. Each sample was qualitatively analyzed through wide scan measurement, and narrow scan measurement was carried on the detected element, and thus, the element ratio was calculated for each sample.

### (2) Method for Measuring Contact Angle of Water on Substrate:

The substrate used in Example and Comparative Examples was cut into strips of approximately 5 mm×50 mm. The above-described sample strips were fixed on a smooth surface with the measuring surface (the surface treated with plasma in Example and Comparative Example 3, the untreated surface in Comparative Example 1, and the surface treated with corona discharge treatment in Comparative Example 2) at the front. The static contact angle of the above-described samples was measured by using a contact angle meter (manufactured by Kyowa Interface Science Co., Ltd.). Distilled water was used as an examination liquid for measurement. That is to say, an approximately 1 μl drop of microscopic water was dropped on the surface of the samples to be measured from a microsyringe, and the contact angle of the water drop after 1 second was calculated in accordance with a 2θ method. This operation was repeated five times and the average value was calculated.

### (3) Method for Measuring Number of Defects in Orientation Layer:

The laminate obtained in Example and Comparative Examples was cut into pieces of 50 mm×50 mm, and the number of defects in the orientation layer was examined for. The surface of the orientation layer was observed with the eye, and the number of approximately circular holes having a diameter of 1 mm or larger generated in the surface of the orientation layer was counted as the number of defects.

### (4) Method for Measuring Intensity of Plasma Treatment:

The intensity of the plasma treatment was calculated by using the following formula.

Amount of plasma treatment [W·sec/cm²]=power [W]÷discharge area [cm²]×treating time [s]

Measurement was carried out with a power of 60 W and a discharge area of 180 mm×30 mm (which coincides with the effective area of the electrode). The treating time was calculated from the rate of feeding of the substrate, which was 2 m/min, and the width of the electrode in the direction of the flow, which was 30 mm.

### (5) Method for Measuring Intensity of Corona Treatment:

The amount of discharge in the corona discharge treatment carried out in Comparative Example 2 was calculated by using the following formula.

Amount of corona discharge [W·min/m²]=power [W]÷feed rate [m/min]÷electrode width [m]

The amount was calculated with a power of 0.15 W, a feed rate of 6 m/min, and an electrode width of 350 mm.

### (6) Method for Measuring Dichroic Ratio:

The transmittance k₁ and the transmittance k₂ for the respective linear polarizations were found by using a spectrometer with an integrating sphere (trade name: “U-4100,” manufactured by Hitachi Ltd.) with complete polarization obtained through a Glan-Thompson prism polarizer as 100%.

The dichroic ratio (DR) was calculated by using the formula: DR=log(1/k₂)/log(1/K₁). Here, k₁ indicates the transmittance when the polarization surface of the entering light beam and the absorption axis of the orientation layer are perpendicular to each other, and k₂ indicates the transmittance when the polarization surface of the entering light beam and the absorption axis of the orientation layer are parallel to each other.

### (7) Method for Measuring Thickness:

A portion of the orientation layer was peeled and the thickness was measured as a step between the orientation layer and the substrate by using a three-dimensional non-contact surface form measuring system (product name: “Micromap MM5200,” manufactured by Ryoka Systems Inc.).

### Example

A plasma treatment was carried out on the surface of a hydrophobic resin substrate containing a norbornane-based resin having a thickness of 100 μm (trade name: “Zeonor,” manufactured by Zeon Corporation) by using a direct type plasma surface processing apparatus (product name: “AP-T05-L150”, manufactured by Sekisui Chemical Co., Ltd.). The plasma treatment was carried out under almost all of an oxygen gas was discharged by filling a nitrogen gas sufficiently. The above-described plasma treatment was carried out with an intensity of 1.0 W·sec/cm².

The carbon ratio, the oxygen ratio, the nitrogen ratio and the contact angle of water on the surface of the substrate on which the plasma treatment was carried out were measured. The results are shown in Table 1.

Next, the solution described below was applied on the surface of the substrate on which the above-described plasma treatment was carried out approximately uniformly by using a wire bar (application rate: 250 mm/se), and after that, this was dried naturally at 25° C. for three minutes. The solution was a sufficiently stirred mixture of an organic dye (trade name: “NO. 15,” manufactured by Optiva Inc.) and water (electrical conductivity: 1 μS/cm). The concentration of the organic dye in this solution was 20% by mass.

A laminate in which an orientation layer of an organic dye was formed on the surface of the above-described substrate was obtained by carrying out the above-described treatment. The dichroic ratio of the thus obtained orientation layer was measured and found to be 16.8 at a wavelength of 540 nm. In addition, the thickness of the orientation layer was 300 nm.

Table 1 shows the number of defects in the orientation layer of this laminate. As shown in Table 1, the laminate obtained in accordance with the method in Example has an extremely small number of defects. This is considered to be because the nitrogen ratio on the surface of the substrate to which the solution was applied was high, the solution was prevented from being repelled, and as a result, the organic dye firmly bonded with the surface of the substrate.

Next, the laminate obtained in Example was left still for 1,000 hours in an environment at 80° C. and 50% RH. Then, the laminate was examined, and it was found that the substrate and the orientation layer had not peeled from each other.

TABLE 1

| | | | | | | Contact | |
|---|---|---|---|---|---|---|---|
| | | | Element ratio on surface of | | | angle | |
| | Processing | | substrate (%) | | | of | Number |
| | of | Filling | Carbon | Oxygen | Nitrogen | water | of |
| | substrate | gas | ratio | ratio | ratio | (°) | defects |
| Example | Plasma | Nitrogen | 78.6 | 4.9 | 17.9 | 29.4 | 2 |
| Comparative | Untreated | — | 98.9 | 1.1 | 0.0 | 95.5 | — |
| Example 1 | | | | | | | |
| Comparative | Corona | — | 88.2 | 11.4 | 0.4 | 50.5 | 150 |
| Example 2 | | | | | | | |
| Comparative | Plasma | Air | 86.1 | 13.3 | 0.65 | 34.9 | 36 |
| Example 3 | | | | | | | |

### Comparative Example 1

A solution was applied on the surface of the substrate in the same manner as in Example, except that the plasma treatment was not carried out.

Herein, the plasma treatment was not carried out in Comparative Example 1, so that the carbon ratio, the oxygen ratio, the nitrogen ratio, and the contact angle of water on the surface of the substrate before the solution was applied were measured. That is to say, the carbon ratio, the oxygen ratio, the nitrogen ratio, and the contact angle of water in Comparative Example 1 shown in Table 1 are values obtained through measurement on the surface of the used hydrophobic resin substrate as they are.

In addition, almost all of the solution was repelled from the surface of the substrate in Comparative Example 1, and therefore, the orientation layer could not be formed on the surface of the substrate. Accordingly, the number of defects in the orientation layer could not be measured in Comparative Example 1.

### Comparative Example 2

A laminate was obtained in the same manner as in Example, except that a corona discharge treatment (amount of discharge: 75 W·min/m²) was carried out instead of the plasma treatment. The thickness of the orientation film in Comparative Example 2 was 300 nm.

Herein, the carbon ratio, the oxygen ratio, the nitrogen ratio and the contact angle of water on the surface of the substrate were measured after the corona discharge treatment was carried out in Comparative Example 2.

Table 1 shows the number of defects in the orientation layer of this laminate. The laminate obtained in accordance with the method in Comparative Example 2 has an extremely great number of defects. This is considered to be because the nitrogen ratio on the surface of the substrate on which the solution was applied was extremely low, and therefore, the organic dye did not bond to the surface of the substrate well.

### Comparative Example 3

A laminate was obtained in the same manner as in Example, except that a plasma treatment was carried out under normal air, instead of carrying out a plasma treatment under a filled nitrogen gas. The thickness of the orientation layer in Comparative Example 3 was 300 nm.

The gas composition of the above-described normal air was approximately 78% of nitrogen, approximately 21% of oxygen, and the rest was argon and carbon dioxide. The gas composition can be measured by separating gases by utilizing the difference in the boiling point.

Herein, the carbon ratio, the oxygen ratio, the nitrogen ratio and the contact angle of water on the surface of the substrate were measured after the plasma treatment was carried out in Comparative Example 3.

Table 1 shows the number of defects in the orientation layer of the laminate of Comparative Example 3. The laminate obtained in accordance with the method in Comparative Example 3 has an extremely great number of defects. This is considered to be because the oxygen ratio on the surface of the substrate was high, and therefore, the nitrogen ratio on the surface of the substrate was extremely low, though the contact angle of water on the surface of the substrate was relatively low, and thus, the organic dye did not bond to the surface of the substrate well.

### INDUSTRIAL APPLICABILITY

As described above, a manufacturing method of a laminate of the present invention provides an excellent orientation layer on a substrate. The laminate of the present invention may be used for a variety of optical applications such as a component member of a liquid crystal display device, for example.

1. A method for manufacturing a laminate having a hydrophobic resin substrate and an orientation layer containing an organic dye, comprising:
a step (1) of carrying out a plasma treatment on a surface of the hydrophobic resin substrate under an atmosphere having a nitrogen concentration of 80% or higher; and
a step (2) of forming the orientation layer containing the organic dye on the hydrophobic resin substrate by applying a solution containing the organic dye exhibiting lyotropic liquid crystallinity and a hydrophilic solvent on the surface of the hydrophobic resin substrate on which the plasma treatment is carried out and drying the solution.

2. The method for manufacturing a laminate according to claim 1, wherein a carbon ratio on the surface of the hydrophobic resin substrate before the plasma treatment is carried out is from 70% to 100% in the step (1), provided that the carbon ratio is measured by X-ray photoelectron spectroscopy.

3. The method for manufacturing a laminate according to claim 1, wherein a contact angle of water on the surface of the hydrophobic resin substrate before the plasma treatment is carried out is from 70° to 130° in the step (1).

4. The method for manufacturing a laminate according to claim 1, wherein the hydrophilic solvent contains water.

5. The method for manufacturing a laminate according to claim 1, wherein an oxygen concentration in the atmosphere where the plasma treatment is carried out is 15% or less in the step (1).

6. The method for manufacturing a laminate according to claim 1, wherein the organic dye has a hydrophilic substituent in a molecular structure.

7. The method for manufacturing a laminate according to claim 6, wherein the hydrophilic substituent is at least one group selected from the group consisting of —COOM, —SO₃M, —PO₃M (provided that M indicates a counter ion), —OH, and —NH₂.

8. The method for manufacturing a laminate according to claim 1, wherein the hydrophobic resin substrate is a film containing a norbornane-based resin as a main component.

9. The method for manufacturing a laminate according to claim 1, wherein a contact angle of water on the surface of the hydrophobic resin substrate on which the plasma treatment is carried out is from 10° to 60° before the solution is applied in the step (2).

10. The method for manufacturing a laminate according to claim 1, wherein a nitrogen ratio on the surface of the hydrophobic resin substrate on which the plasma treatment is carried out is from 3% to 25% before the solution is applied in the step (2), provided that the nitrogen ratio is measured by X-ray photoelectron spectrometry.

11. The method for manufacturing a laminate according to claim 1, wherein a thickness of the orientation layer is from 0.1 μm to 2 μm.

12. A laminate, comprising a hydrophobic resin substrate and an orientation layer containing an organic dye which dissolves in a hydrophilic solvent and exhibits lyotropic liquid crystallinity, wherein
a nitrogen ratio on a surface of the hydrophobic resin substrate on which the orientation layer is laminated is from 3% to 25%, provided that the nitrogen ratio is measured by X-ray photoelectron spectrometry.
